(19) United States
(12) Patent Application Publication
(10) Pub. No.: US 2011/0236682 A1
(43) Pub. Date: Sep. 29, 2011

(54) ACRYLIC PRESSURE-SENSITIVE ADHESIVE SHEET, ACRYLIC PRESSURE-SENSITIVE ADHESIVE SHEET MANUFACTURING METHOD, AND LAMINATED CONSTRUCTION

(75) Inventors: Masayuki Okamoto, Osaka (JP); Masahito Niwa, Osaka (JP); Naoaki Higuchi, Osaka (JP)

(73) Assignee: NITTO DENKO CORPORATION, Osaka (JP)

(21) Appl. No.: 13/132,134

(22) PCT Filed: Dec. 1, 2009
(86) PCT No.: PCT/JP2009/070164

§ 371 Date: Jun. 1, 2011

(30) Foreign Application Priority Data
Dec. 1, 2008 (JP) 2008-306341

(51) Int. Cl. C09J 7/02; B05D 3/06; B29C 39/00; C09J 133/26; C09J 139/06

(52) U.S. Cl. 428/355 CN; 427/487; 526/304; 526/264; 525/328.8

(57) ABSTRACT

The present invention provides a pressure-sensitive adhesive sheet having a pressure-sensitive adhesive layer which has both high corrosion resistance and adhesion reliability. The acrylic pressure-sensitive adhesive sheet of the present invention contains at least an acrylic pressure-sensitive adhesive layer containing as a main component an acrylic polymer formed from a composition containing a monomer mixture or a partially polymerized product thereof, in which the monomer mixture contains the following (m1), (m2) and (m3), or (m1), (m2), (m3) and (m4), and in which a content of each component (m1), (m2), (m3), and (m4) is 35 to 97.5% by mass, 2 to 40% by mass, 0.1 to 25% by mass, and 0 to 30% by mass, respectively:
(m1) an alkyl(meth)acrylate monomer having an alkyl group with 1 to 12 carbon atoms, which is represented by Formula (1),

[Chem. 1]

CH₂═C(R¹)COOR² (1)
(in Formula (I), R¹ represents a hydrogen atom or a methyl group, and R² represents an alkyl group with 1 to 12 carbon atoms);
(m2) a vinylic monomer having a nitrogen atom(s) in its skeleton (excluding (m3));
(m3) an N-hydroxyalkyl(meth)acrylamide monomer having a hydroxyalkyl group with 1 to 4 carbon atoms; and
(m4) a monomer copolymerizable with the above-described (m1) to (m3).

### FIELD OF THE INVENTION

The present invention relates to an acrylic pressure-sensitive adhesive sheet comprising an acrylic pressure-sensitive adhesive layer having both corrosion resistance and adhesion reliability, a method for manufacturing the acrylic pressure-sensitive adhesive sheet, and a laminated construction of the acrylic pressure-sensitive adhesive sheet with an optical member.

### BACKGROUND OF THE INVENTION

Recently, for the purpose of protecting a display panel in flat-panel displays such as plasma display (PDP), liquid crystal display (LCD), organic EL display, and field emission display (FED), the constitution of providing a surface of the display panel with a resin plate such as acrylic plate or polycarbonate plate having a good impact-resistance, or with a protective plate (protective panel) such as reinforced glass has received attentions.

Most of such protective panels have constitutions for preventing a breakage by providing an empty wall between the protective panel and the display panel so that an impact applied to the protective panel of surface does not transfer directly to the display panel. However, there is a problem that the empty wall causes ghost image by multi-reflection, or limits the formation of a thin film.

For this reason, a method of filling the empty wall between the protective panel and the display panel with, for example, a pressure-sensitive adhesive layer having high transparency has been recently proposed. Generally, as the pressure-sensitive adhesive having good transparency, acrylic pressure-sensitive adhesives are used, and as a polymer used in the acrylic polymers constituting such pressure-sensitive adhesives, a combination of acrylic acid ester monomers and carboxyl group-having monomers such as acrylic acid as a cohesive component is often employed.

Meanwhile, touch panel-type displays have received vigorous attentions as a trend for display system. In this case, for example, when the above-mentioned pressure-sensitive adhesives containing carboxyl group such as acrylic acid are used for the purpose of filling the empty wall between the front protective panel (also acting for breakage prevention of display panel) and the display panel with a transparent electrode such as ITO (Indium-Tin Oxide, oxide of indium and tin) provided on a surface thereof, it is expected that corrosion in the transparent electrode layer occurs with time and that function deterioration of the touch panel occurs depending on a change in electrical impedance.

In addition, when such a pressure-sensitive adhesive is laminated with a resin plate such as an acrylic plate or a polycarbonate plate, it may be often required a property (floating and peeling resistance property) such that a peeling or floating by air bubbles generated from the resin plate may not occur at an adhesive interface under a stringent condition. In consideration for these requirements, acrylic optical pressure-sensitive adhesives containing no or title carboxyl group-having monomers are disclosed, for example, in Patent Documents 1 and 2. Further, the pressure-sensitive adhesives disclosed in Patent Documents 1 and 2 are considered to have some corrosion resistance for ITO transparent electrodes and the like. Moreover, a silicone gel-type optical pressure-sensitive adhesive sheet is disclosed in Patent Document 3. However, the pressure-sensitive adhesives disclosed in the above Patent Documents do not involve sufficient floating and peeling resistance property as compared with pressure-sensitive adhesives containing a carboxyl group-having monomer as a monomer component.

In addition, a polarizer (optical) pressure-sensitive adhesive is disclosed in Patent Document 4, where N-vinyl-2-pyrrolidone monomer is used to impart cohesiveness to the pressure-sensitive adhesive. However, it also discloses that cohesiveness is not sufficient if carboxyl group-having monomer is not contained at an amount of more than 1 part by mass. Therefore, this pressure-sensitive adhesive involves a remaining concern with regard to corrosion resistance for ITO transparent electrodes.

### PRIOR ART DOCUMENTS

### Patent Documents

Patent Document 1: JP 2005-298723 A

Patent Document 2: JP 2005-314453 A

Patent Document 3: JP 2006-290960 A

Patent Document 4: JP 5-107410 A

### SUMMARY OF THE INVENTION

### Technical Problem

Accordingly, there has been a demand for development of an optical pressure-sensitive adhesive involving both high corrosion resistance for transparent electrodes such as ITO and sufficient floating and peeling resistance property upon lamination with a resin plate, and being particularly useful for optical applications.

To this end, an object of the present invention is to provide a pressure-sensitive adhesive sheet having a pressure-sensitive adhesive layer which has both high corrosion resistance and adhesion reliability, and particularly to provide a pressure-sensitive adhesive sheet having a pressure-sensitive adhesive layer which has both high corrosion resistance for transparent electrodes such as ITO and adhesion reliability upon lamination with a resin plate.

### Solution to Problem

As a result of intensive investigations to solve the aforementioned problems, the present inventors have found that an acrylic pressure-sensitive adhesive layer containing as a base polymer an acrylic polymer obtained by copolymerizing an alkyl(meth)acrylate monomer, a vinylic monomer having a nitrogen atom(s) in its skeleton, and an N-hydroxyalkyl(meth)acrylamide monomer as a cohesiveness-supplementing component in a predetermined ratio has both high corrosion resistance and adhesion reliability, and thus the present invention has been completed.

The present invention provides an acrylic pressure-sensitive adhesive sheet comprising at least an acrylic pressure-sensitive adhesive layer comprising as a main component an acrylic polymer formed from a composition comprising a monomer mixture or a partially polymerized product thereof, wherein the monomer mixture comprises the following (m1), (m2) and (m3), or (m1), (m2), (m3) and (m4), and wherein a content of each component (m1), (m2), (m3), and (m4) is 35 to 97.5% by mass, 2 to 40% by mass, 0.1 to 25% by mass, and 0 to 30% by mass, respectively:

(m1) an alkyl(meth)acrylate monomer having an alkyl group with 1 to 12 carbon atoms, which is represented by Formula (1).

[Chem. 1]

CH₂═C(R¹)COOR² (1)

(in Formula (1), R¹ represents a hydrogen atom or a methyl group, and R² represents an alkyl group with 1 to 12 carbon atoms);

(m2) a vinylic monomer having a nitrogen atom(s) in its skeleton (excluding (m3));

(m3) an N-hydroxyalkyl(meth)acrylamide monomer having a hydroxyalkyl group with 1 to 4 carbon atoms; and

(m4) a monomer copolymerizable with the above-described (m1) to (m3),

The present invention further provides the above-described acrylic pressure-sensitive adhesive sheet, wherein the vinylic monomer having a nitrogen atom(s) in its skeleton (m2) is one or two or more monomers selected from N-vinyl cyclic amides represented by Formula (2), or (meth)acrylamides.

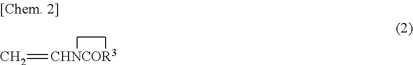

(in Formula (2), R³ represents a divalent organic group).

The present invention further provides the acrylic pressure-sensitive adhesive sheet, wherein the composition containing the monomer mixture or the partially polymerized product thereof further comprises a cross-linking agent added in an amount of 0.001 to 5 parts by mass with respect to 100 parts by mass of monomer components constituting the monomer mixture.

The present invention further provides the acrylic pressure-sensitive adhesive sheet, wherein the acrylic pressure-sensitive adhesive sheet is used for optical members.

The present invention further provides the acrylic pressure-sensitive adhesive sheet, wherein the acrylic pressure-sensitive adhesive sheet is a baseless-type both-sides pressure-sensitive adhesive sheet consisting of the acrylic pressure-sensitive adhesive layer.

The present invention provides a method of manufacturing an acrylic pressure-sensitive adhesive sheet, wherein the method comprises:

(i) process of preparing a composition comprising: at least a monomer mixture or a partially polymerized product thereof, wherein the monomer mixture comprises the following (m1), (m2) and (m3), or (m1), (m2), (m3) and (m4), and wherein a content of each component (m1), (m2), (m3), and (m4) is 35 to 97.5% by mass, 2 to 40% by mass, 0.1 to 25% by mass, and 0 to 30% by mass, respectively; and 0.001 to 5 parts by mass of a photopolymerization initiator with respect to 100 parts by mass of monomer components constituting the monomer mixture or the partially polymerized product thereof;

(ii) process of applying the composition prepared in process (i) on a support; and

(iii) process of curing the composition applied on the support by irradiating with an active energy beam to form an acrylic pressure-sensitive adhesive layer:

(m1) an alkyl(meth)acrylate monomer having an alkyl group with 1 to 12 carbon atoms, which is represented by Formula (1).

[Chem. 3]

CH₂═C(R¹)COOR² (1)

(in Formula (1), R¹ represents a hydrogen atom or a methyl group, and R² represents an alkyl group with 1 to 12 carbon atoms);

(m2) a vinylic monomer having a nitrogen atom(s) in its skeleton;

(m3) an N-hydroxyalkyl(meth)acrylamide monomer having a hydroxyalkyl group with 1 to 4 carbon atoms; and

(m4) a monomer copolymerizable with the above-described (m1) to (m3).

The present invention further provides a laminated construction of an acrylic pressure-sensitive adhesive sheet and an optical member in a contact state of the acrylic pressure-sensitive adhesive layer with the optical member, wherein the acrylic pressure-sensitive adhesive sheet is the above-described acrylic pressure-sensitive adhesive sheet.

### Advantageous Effects of Invention

Since the acrylic pressure-sensitive adhesive sheet of the present invention is provided with the above construction, it has both high corrosion resistance and adhesion reliability. In particular, it has both high corrosion resistance for transparent electrodes such as ITO and adhesion reliability upon lamination with a resin plate.

### BRIEF DESCRIPTION OF THE DRAWINGS

FIG. 1 is a cross-sectional view showing one capacitance-type touch panel formed by laminating members using an acrylic pressure-sensitive adhesive sheet of the present invention.

FIG. 2 is a cross-sectional view showing another capacitance-type touch panel formed by laminating members using an acrylic pressure-sensitive adhesive sheet of the present invention.

FIG. 3 is a cross-sectional view showing one resistive-type touch panel formed by laminating members using an acrylic pressure-sensitive adhesive sheet of the present invention.

### MODE FOR CARRYING OUT THE INVENTION

An acrylic pressure-sensitive adhesive sheet of the present invention has at least an acrylic pressure-sensitive adhesive layer containing as a main component an acrylic polymer formed from a composition containing a monomer mixture or a partially polymerized product thereof, wherein the monomer mixture contains the following (m1), (m2) and (m3), or (m1), (m2), (m3) and (m4), and wherein the content of each component (m1), (m2), (m3) and (m4) is 35 to 97.5% by mass, 2 to 40% by mass, 0.1 to 25% by mass, and 0 to 30% by mass for (m1), (m2), (m3), and (m4), respectively.

(m1) an alkyl(meth)acrylate monomer having an alkyl group with 1 to 12 carbon atoms, which is represented by Formula (1) (hereinafter, also referred to as (m1)),

[Chem. 4]

CH₂═C(R¹)COOR² (1)

(in Formula (1), R¹ represents a hydrogen atom or a methyl group, R² represents an alkyl group with 1 to 12 carbon atoms),

(m2) a vinylic monomer having a nitrogen atom(s) in its skeleton (hereinafter, also referred to as (m2)),

(m3) an N-hydroxyalkyl(meth)acrylamide monomer having a hydroxyalkyl group with 1 to 4 carbon atoms (hereinafter, also referred to as (m3)), and

(m4) a monomer copolymerizable with the above-described (m1) to (m3) (hereinafter, also referred to as (m4)).

Herein, a monomer mixture refers to a mixture containing the above-described (m1), (m2) and (m3), or (m1), (m2), (m3) and (m4), and a partially polymerized product thereof refers to a product that some of the monomer mixture is partially polymerized.

The acrylic pressure-sensitive adhesive sheet having such an acrylic pressure-sensitive adhesive layer exerts a property involving both high corrosion resistance and adhesion reliability, particularly, involving both high corrosion resistance for transparent electrodes such as ITO and adhesion reliability upon lamination with a resin plate, in a pressure-sensitive adhesive layer surface (pressure-sensitive adhesive face, surface of pressure-sensitive adhesive layer, adhesive face) provided by the pressure-sensitive adhesive layer. Thus, the acrylic pressure-sensitive adhesive sheet of the present invention may be suitably used for optical members, for example, for laminating optical members.

The acrylic pressure-sensitive adhesive sheet of the present invention may be a both-sides pressure-sensitive adhesive sheet (both-sides adhesive sheet) which both sides of the sheet are the adhesive faces, or may be an one-side pressure-sensitive adhesive sheet (one-side adhesive sheet) which one side of the sheet is the adhesive face. In addition, the acrylic pressure-sensitive adhesive sheet of the present invention may be a baseless-type having no base (base layer), or may be a base-type having a base (base layer). The baseless-type may be a sheet including only the acrylic pressure-sensitive adhesive layer, or a sheet including the acrylic pressure-sensitive adhesive layer together with other pressure-sensitive adhesive layers (pressure-sensitive adhesive layers other than the above-described acrylic pressure-sensitive adhesive layer). Furthermore, herein, the ‘pressure-sensitive adhesive sheet’ encompasses a tape-type sheet, i.e. ‘pressure-sensitive adhesive tape’.

(Acrylic Pressure-Sensitive Adhesive Layer)

According to an aspect of the present invention, the acrylic pressure-sensitive adhesive layer gives a pressure-sensitive adhesive layer surface having both corrosion resistance and adhesion reliability. Because the acrylic pressure-sensitive adhesive layer involve good adhesion property to adherends, and also because ‘peeling’ or ‘floating’ is not generated at an adhesive interface by air bubbles even when the air bubbles generate from the adherend, good adhesion reliability may exerts upon lamination with resin plate.

The acrylic pressure-sensitive adhesive layer contains as a main component an acrylic polymer formed by a composition containing a monomer mixture or a partially polymerized product thereof as described below. Also, if necessary, an optional component (for example, a polymer other than the acrylic polymer, an additive, etc.) may be further incorporated so long as it does not impair the effect of the present invention.

In the acrylic pressure-sensitive adhesive layer, the acrylic polymer as the main component may be preferably included at an amount of 50% by mass or more (e.g., 50 to 100% by mass), and more preferably, 70% by mass or more (e.g., 70 to 100% by mass) based on the total mass of the acrylic pressure-sensitive adhesive layer. If the content of the acrylic polymer is less than 50% by mass, the acrylic pressure-sensitive adhesive layer may fail to exert the aforementioned properties. Moreover, the acrylic pressure-sensitive adhesive layer may be consisting of the acrylic polymer as the main component.

The acrylic polymer is formed from a composition containing a monomer mixture or a partially polymerized product thereof, in which the monomer mixture contains the aforementioned (m1), (m2) and (m3), or (m1), (m2), (m3) and (m4), and wherein the content of each component (m1), (m2), (m3) and (m4) is 35 to 97.5% by mass, 2 to 40% by mass, 0.1 to 25% by mass, and 0 to 30% by mass, respectively. Herein, the composition containing the monomer mixture or the partially polymerized product thereof may be also referred to as ‘acrylic polymerizable composition’.

In addition to the monomer mixture or the partially polymerized product thereof, the acrylic polymerizable composition may further contain an optional component (for example, a polymer other than the acrylic polymer, an additive, etc.) within the range that it does not adversely affect an effect of the present invention.

Monomer components constituting the monomer mixture may include (m1), (m2), (m3) and (m4). Among them, (m1), (m2) and (m3) are essential components, and (m4) is an optional component which is used if necessary.

If the optional component (m4) is used in the monomer mixture, it is important that the total amount of the essential components (m1), (m2) and (m3) is preferably 70% by mass or more (e.g., 70 to 95% by mass), and more preferably 80% by mass or more (e.g., 80 to 95% by mass) based on the total mass of the constituting monomer components. That is because a problem may be generated in terms of adhesion reliability to adherends if the total amount of (m1), (m2) and (m3) is less than 70% by mass.

Examples of the alkyl(meth)acrylate monomer having an alkyl group (straight or branched alkyl group) with 1 to 12 carbon atoms represented by Formula (1) (m1) include methyl(meth)acrylate, ethyl(meth)acrylate, n-propyl(meth)acrylate, isopropyl(meth)acrylate, n-butyl(meth)acrylate, isobutyl(meth)acrylate, sec-butyl(meth)acrylate, t-butyl(meth)acrylate, pentyl(meth)acrylate, isopentyl(meth)acrylate, hexyl(meth)acrylate, heptyl(meth)acrylate, n-octyl(meth)acrylate, isooctyl(meth)acrylate, 2-ethylhexyl(meth)acrylate, nonyl(meth)acrylate, isononyl(meth)acryl ate, decyl(meth)acrylate, isodecyl(meth)acrylate, undecyl(meth)acrylate, and dodecyl(meth)acrylate. Among them, alkyl(meth)acrylate monomers having an alkyl group (straight or branched alkyl group) with 4 to 12 carbon atoms are preferred, and n-butyl(meth)acrylate, 2-ethylhexyl(meth)acrylate, isooctyl(meth)acrylate, isononyl(meth)acrylate, and the like are particularly suitable. In this regard, the alkyl(meth)acrylate monomer having an alkyl group with 1 to 12 carbon atoms represented by Formula (1) (m1) may be used alone or in combination of two or more thereof.

The content of (m1) in the monomer mixture is 35 to 97.5% by mass, preferably 45 to 99% by mass, and more preferably 55 to 90% by mass based on the total mass of the constituting monomer components. If the content of (m1) is less than 35% by mass, there may be problems that it is difficult to exert initial adhesiveness at conditions such as room temperature or low temperature, or an impact applied to a protective panel is easy to transfer to a display panel due to the lowering of its impact-absorbing function. On the other hands, if the content of (m2) is more than 97.5% by mass, there may be a problem that adhesion reliability to adherends or processability of a pressure-sensitive adhesive sheet is lowered due to a lack of contents of (m2) and (m3) components.

The vinylic monomer having a nitrogen atom(s) in its skeleton (m2) is a monomer having at least one carbon-carbon double bond and a nitrogen atom(s) in its molecule (in its molecular skeleton). In this context, the N-hydroxyalkyl(meth)acrylamide monomer having a hydroxyalkyl group with 1. to 4 carbon atoms (m3) is not included in (m2). Herein, ‘vinylic monomer having a nitrogen atom(s) in its skeleton’ is also referred to as ‘nitrogen-having vinylic monomer’.

In the acrylic pressure-sensitive adhesive sheet of the present invention, since the nitrogen-having vinylic monomer (m2) is used as a monomer component constituting an acrylic polymer which is the main component of the acrylic pressure-sensitive adhesive layer, adhesiveness, cohesiveness, and the like may be enhanced. Also, (m3) component as described below has low compatibility with (m1), but the compatibility may be enhanced by adding (m2) component.

More specifically, examples of the nitrogen-having vinylic monomer (m2) include one or two or more monomers selected from N-vinyl cyclic amides represented by Formula (2) and (meth)acrylamides.

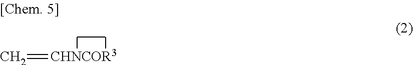

(in Formula 2, R³ represents a divalent organic group).

Furthermore, in Formula (2), R³ preferably represents a saturated or unsaturated hydrocarbon group, and more preferably a saturated hydrocarbon group (for example, an alkylene group with 3 to 5 carbon atoms).

Examples of the N-vinyl cyclic amides represented by Formula (2) include N-vinyl-2-pyrrolidone, N-vinyl-2-piperidone, N-vinyl-3-morpholinone, N-vinyl-2-caprolactam, N-vinyl-1,3-oxazine-2-on, N-vinyl-3,5-morpholinedione, N-vinylpyridine, N-vinylpyrimidine, N-vinylpiperazine, N-vinylpyrrole, and the like. Among them, N-vinyl-2-pyrrolidone and N-vinyl-2-caprolactam are particularly preferred.

Further, examples of the (meth)acrylamides include (meth)acrylamide, N-alkyl(meth)acrylamides, N,N-dialkyl(meth)acrylamides, and the like. Examples of N-alkyl(meth)acrylamides include N-ethyl(meth)acrylamide, N-n-butyl(meth)acrylamide, N-octylacrylamide, and the like. In addition, it also includes amino group-having (meth)acrylamides such as dimethylaminoethyl(meth)acrylamide, and diethylaminoethyl(meth)acrylamide. Examples of N,N-dialkyl(meth)acrylamides include N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, N,N-di(t-butyl)(meth)acrylamide, and the like. Among them, the use of (meth)acrylamides having one or two N-alkyl groups with 1 to 4 (more preferably 1 to 2) carbon atoms (e.g., N,N-dialkylacrylamides such as N,N-diethylacrylamide, and N,N-dimethylacrylamide) is preferred in terms of maintaining the balance between adhesion reliability and flexibility of a pressure-sensitive adhesive sheet.

Further, examples of the nitrogen-having vinylic monomers other than the N-vinyl cyclic amides and the (meth)acrylamides include: cyclic (meth)acrylamides having N-acryloyl groups such as (meth)acryloylmorpholine, (meth)acryloylpyrrolidone, and (meth)acryloylpyrolidine; monomers having an amino group such as aminoethyl(meth)acrylate, N,N-dimethylaminoethyl(meth)acrylate, and N,N-dimethylaminopropyl(meth)acrylate; monomers having maleimide skeleton such as N-cyclohexylmaleimide, and N-phenylmaleimide; itaconimide monomers such as N-methylitaconimide, N-ethylitaconimide, N-butylitaconimide, N-2-ethylhexylitaconimide, N-laurylitaconimide, and N-cyclohexylitaconimide; cyanoacrylate monomers such as acrylonitrile, and methacrylonitrile; and succinimide monomers such as N-(meth)acryloyloxymethylenesuccin imide, N-(meth)acryloyl-6-oxyhexamethylenesuccinimide, and N-(meth)acryloyl-8-oxyoctamethylenesuccinimide.

Also, as the nitrogen-having vinylic monomer (m2), the use of a combination of N-vinylic cyclic amide represented by Formula (2) and (meth)acrylamides is useful in maintaining the property balance among adhesiveness, cohesiveness, and flexibility, and processability of a pressure-sensitive adhesive sheet.

The content of the nitrogen-having vinylic monomer (m2) in the monomer mixture is 2 to 40% by mass, preferably 2.5 to 35% by mass, and more preferably 3 to 30% by mass based on the total mass of the constituting monomer components. If the content of (m2) is less than 2% by mass, there may be problems that the processability of the sheet is lowered or adhesion reliability may be deteriorated. If the content of (m2) is more than 40% by mass, there may be problems of reduced flexibility of the sheet or reduced tackiness.

The N-hydroxyalkyl(meth)acrylamide monomer having a hydroxyalkyl group with 1 to 4 carbon atoms (m3) may improve durability against conditions that a constant force is applied for a long time such as repelling resistance or foaming and peeling resistance tests. Also, since it has a hydroxyl group as a reactive functional group, a cross-linking structure may be formed by reacting with a cross-linking agent having isocyanate group, epoxy group or the like. Herein, (m3) is common to (m2) in having a carbon-carbon double bond and a nitrogen atom(s) in its skeleton, but (m3) is excluded from (m2). Furthermore, (m3) may be used alone or in combination of two or more thereof.

The N-hydroxyalkyl(meth)acrylamide monomer having a hydroxyalkyl group with 1 to 4 carbon atoms (m3)is represented by Formula (3).

[Chem. 6]

CH₂═C(R⁴)CONR⁵R⁶ (3)

(in Formula (3), R⁴ represents a hydrogen atom or a methyl group, R⁵ represents a hydroxylalkyl group with 1 to 4 carbon atoms, and R⁶ represents a hydrogen atom or a saturated or unsaturated hydrocarbon group with 1 to 10 carbon atoms).

In this regard, in Formula (3), R⁵, hydroxylalkyl group with 1 to 4 carbon atoms may have a straight chain structure, or may have a branched chain structure.

Examples of (m3) include N-methylol(meth)acrylamide, N-(2-hydroxyethyl)acrylamide, N-(2-hydroxyethyl)methacrylamide, N-(2-hydroxypropyl)acrylamide, N-(2-hydroxypropyl)methacrylamide, N-(1-hydroxypropyl)acrylamide, N-(1-hydroxypropyl)methacrylamide, N-(3-hydroxypropyl)acrylamide, N-(3-hydroxypropyl)methacrylamide, N-(2-hydroxybutyl)acrylamide, N-(2-hydroxybutyl)methacrylamide, N-(3-hydroxybutyl)acrylamide, N-(3-hydroxybutyl)methacrylamide, N-(4-hydroxybutyl)acrylamide, N-(4-hydroxybutyl)methacrylamide, and N-methyl-N-2-hydroxyethyl(meth)acrylamide. Among them, N-(2-hydroxyethyl)acrylamide, N-(2-hydroxyethyl)methacrylamide, N-methylol(meth)acrylamide, N-(3-hydroxypropyl)acrylamide, and the like are preferred in terms of capability of forming an acrylic pressure-sensitive adhesive layer exhibiting good balance between hydrophilicity and hydrophobicity as well as excellent balance in adhesion properties, N-(2-hydroxyethyl)acrylamide, N-(2-hydroxyethyl)methacrylamide, and N-methylol(meth)acrylamide are particularly preferred.

The content of (m3) in the monomer mixture is 0.1 to 25% by mass, preferably 0.2 to 15% by mass, and more preferably 0.3 to 10% by mass based on the total mass of the constituting monomer components. If the content of (m3) is less than 0.1% by mass, there may be a problem that the resulting pressure-sensitive adhesive sheet becomes hard to exert its adhesion reliability to adherends. On the other hands, if the content of (m3) is more than 25% by mass, there may be problems that the compatibility of (m3) component is deteriorated and thus transparency is lowered (optical property, is impaired).

Herein, together with (m1), (m2) and (m3), (m4) [a monomer copolymerizable with (m1), (m2) and (m3) (this monomer may be also referred to as ‘copolymerizable monomer’)] may be used. When the copolymerizable monomer is used, for example, the compatibility of the (m3) component may be enhanced, or the balance of adhesion property, flexibility, processability, transparency and the like may be well maintained.

Such copolymerizable monomers may be monofunctional monomers, and examples of such monomers include hydroxyl group-having monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methyl acrylate; sulfonate group-having monomers such as 2-acrylamide-2-methylpropane sulfonic acid, and sulfopropylacrylate; phosphate group-having monomers such as 2-hydroxyethylacryloyl phosphate; vinylic monomers such as vinyl acetate, N-vinylcarboxylic acid amide, and styrene; acrylic acid ester monomers such as (meth)acrylate glycidyl, tetrahydrofurfuryl(meth)acrylate, polyethyleneglycol(meth)acrylate, polypropylene glycol(meth)acrylate, fluorine(meth)acrylate, silicon(meth)acrylate, and 2-methoxyethylacrylate; alkyl(meth)acrylates having an alkyl group, other than the alkyl(meth)acrylates constituting main component described above such as methyl(meth)acrylate or octadecyl(meth)acrylate; alicyclic acrylates such as isobornyl(meth)acrylate; and the like. One or two or more of these copolymerizable monomers can be used.

Among these copolymerizable monomers, 2-hydroxyethyl(meth)acrylate, 4-hydroxybutyl(meth)acrylate and 2-methoxyethylacrylate are preferred in terms of maintaining the balance among adhesion reliability, flexibility, processability and transparency of the pressure-sensitive adhesive sheet, and 4-hydroxybutyl(meth)acrylate and 2-methoxyethylacrylate are particularly preferred.

When (m4) is used, the content of (m4) in the monomer mixture is preferably less than 30% by mass (preferably 1 to 30% by mass), and more preferably less than 25% by mass (preferably 1 to 25% by mass) based on the total mass of the constituting monomer components. If the content of (m4) is more than 30% by mass, a problem may be generated with respect to the balance between adhesion reliability and flexibility of the pressure-sensitive adhesive sheet.

In the present invention, (m1), (m2) and (m3) are essential as monomer components constituting an acrylic polymer which is the main component of the acrylic pressure-sensitive adhesive layer. That is, as monomer components other than (m1), (m2) and (m3) are used in combination.

Accordingly, even though a carboxyl group-having monomer as the copolymerizable monomer (m4) (for example, ethylenic unsaturated monocarboxylic acid (e.g., acrylic acid, methacrylic acid, crotonic acid, carboxyethyl acrylate, carboxypentyl acrylate, etc.), ethylenic unsaturated dicarboxylic acid (e.g., maleic acid, itaconic acid, citraconic acid, etc.), anhydrous ethylenic unsaturated dicarboxylic acid (e.g., anhydrous maleic acid, anhydrous itaconic acid, etc.) and the like] is not substantially contained in the monomer components constituting the acrylic polymer, cohesiveness of an acrylic pressure-sensitive adhesive layer is improved, thereby exerting good adhesion reliability to adherends, as in the case that a carboxyl group-having monomer (in particular, acrylic acid) is used as a copolymerizable monomer. Herein, the ‘carboxyl group-having monomer’ refers to a vinyl monomer (ethylenic unsaturated monomer) having at least one carboxyl group (which may be anhydrous form) in one molecule.

Accordingly, when the acrylic pressure-sensitive adhesive sheet of the present invention is used for adherends which involves a concern of corrosion by an acidic component (for example, transparent electrodes represented by ITO, adherends made of a metal material, sputtered silver having an electromagnetic wave-absorbing function, optical films with a cupper mesh provided on its surface, and earth electrodes), in terms of preventing corrosion of adherends, it is preferred that a carboxyl group-having monomer is not substantially contained in the monomer mixture.

Thus, an acrylic pressure-sensitive adhesive layer containing as a main component an acrylic polymer formed by a composition containing a monomer mixture which does not substantially contain a carboxyl group-having monomer, or a partially polymerized product thereof, can exert high adhesion reliability to adherends involving a concern of corrosion by an acidic component and highly prevent corrosion incidences, even though it does not substantially contain the carboxyl group-having monomer as the copolymerizable monomer (m4).

Herein, the phrase ‘not substantially contain’ indicates that such a component is not at all contained, or its content is no more than 0.1% by mass based on the total mass of monomer components. For example, what a carboxyl group-having monomer ‘is not substantially contained’ as monomer components indicates that the carboxyl group-having monomer is not at all contained as monomer components, or its content is no more than 0.1% by mass based on the total mass of monomer components.

The monomer mixture can be prepared by mixing (m1) to (m3) and if necessary (m4) at predetermined amounts for respective components using a method known in the art. The monomer mixture may also be a partially polymerized product obtained by polymerizing some of the monomer components for the purpose of adjustment of viscosity, etc. if necessary. A method for preparing the partially polymerized product is not particularly limited, and for example, in the case of photopolymerization, a photopolymerization initiator may be added to the monomer mixture prepared, and the resulting monomer mixture may be irradiated with an active energy beam (for example, ultraviolet irradiation, etc.) to generate photopolymerization, and then the composition in which some of the monomer components is polymerized may be prepared.

The acrylic polymer may be formed from the acrylic polymerizable composition containing the monomer mixture or a partially polymerized product thereof using a known or commonly used polymerization method. Examples of such a polymerization method include methods such as solution polymerization, emulsion polymerization, bulk polymerization, and photo polymerization. Among them, for the production of an acrylic polymer of the present invention, a curing reaction by heat or active energy beam using polymerization initiators such as thermal polymerization initiators or photopolymerization initiators may be preferably used in terms of workability, thick-coating property, and low environmental load. Such polymerization initiators may be used alone or in combination of two or more thereof.

Examples of the photo polymerization initiators are not particularly limited, and include benzoin ether photopolymerization initiators, acetophenone photopolymerization initiators, α-ketol photopolymerization initiators, aromatic sulfonyl chloride photopolymerization initiators, photo-active oxime photopolymerization initiators, benzoin photopolymerization initiators, benzyl photopolymerization initiators, benzophenone photopolymerization initiators, ketal photopolymerization initiators, thioxanthone photopolymerization initiators, α-hydroxyketone photopolymerization initiators, α-aminoketone photopolymerization initiators, acylphosphine oxide photopolymerization initiators, and the like.

Specifically, examples of the ketal photopolymerization initiators include 2,2-dimethoxy-1,2-diphenylethane-1-on (trade name ‘IRGACURE 651’ manufactured by Ciba Japan K.K.), benzyl dimethyl ketal, and the like. Examples of the α-hydroxyketone photopolymerization initiators include 1 -hydroxy-cyclohexyl-phenylketone (trade name IRGACURE 184′ manufactured by Ciba Japan K.K.), 2-hydroxy-2-methyl-1-phenyl-propane-1-on (trade name ‘DAROCURE 1173’ manufactured by Ciba Japan K.K.), 1-[4-(2-hydroxyethoxy)-phenyl]-2-hydroxy-2-methyl-1-propane-1-on (trade name ‘IRGACURE 2959’ manufactured by Ciba Japan K.K.), and the like. Examples of the α-aminoketone photopolymerization initiators include 2-methyl-1[4-(methylthio)phenyl]-2-morpholinopropane-1-on (trade name ‘IRGACURE 907’ manufactured by Ciba Japan K.K.), 2-benzyl-2-dimethylamino-1-(4-morpholinophenyl)-butanon-1 (trade name IRGACURE 369′ manufactured by Ciba Japan K.K.), and the like. Examples of the acylphosphine oxide photopolymerization initiators include 2,4,6-trimethylbenzoyldiphenylphosphine oxide (trade name ‘LUCIRIN TPO’ manufactured by BASF corporation), and the like. Examples of the benzoin ether photopolymerization initiators include benzoin methylether, benzoin ethylether, benzoin propylether, benzoin isopropylether, benzoin isobutylether, anisolemethylether, and the like. Examples of the acetophenone photopolymerization initiators include 2,2-diethoxyacetophenone, 2,2-dimethoxy-2-phenylacetophenone, 1-hydroxycyclohexylphenylketone, 4-phenoxydichloroacetophenone, 4-t-butyl-dichloroacetophenone, and the like. Examples of the α-ketol photopolymerization initiators include 2-methyl-2-hydroxypropiophenone, 1-[4-(2-hydroxyethyl)-phenyl]-2-hydroxy-methylpropane-1-on, and the like. Examples of the aromatic sulfonyl chloride photopolymerization initiators include 2-naphthalene sulfonyl chloride and the like. Examples of the photo-active oxime photopolymerization initiators include 1-phenyl-1,1-propanedione-2-(o-ethoxycarbonyl)-oxime and the like. Examples of the benzoin photopolymerization initiators include benzoin and the like. Examples of the benzyl photopolymerization initiators include benzyl and the like. Examples of the benzophenone photopolymerization initiators include benzophenone, benzoyl benzoic acid, 3,3′-dimethyl-4-methoxybenzophenone, polyvinylbenzophenone, α-hydroxycyclohexyl phenyl ketone, and the like. Examples of the thioxanthone photopolymerization initiators include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, dodecylthioxanthone, and the like.

Examples of the thermal polymerization initiators include; azo thermal polymerization initiators such as 2,2′-azobisisobutyronitrile, 2,2′-azobis-2-methylbutyronitrile, 2,2′-azobis(2-methylpropionic acid)dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine)dihydrochloride; peroxide thermal polymerization initiators such as dibenzoylperoxide, and tert-butylpermaleate; redox thermal polymerization initiators; and the like. The amount of thermal polymerization initiators used is not particularly limited, as long as it is within ranges usable as general thermal polymerization initiators.

The content of the photopolymerization initiator in the acrylic polymerizable composition is not particularly limited. However, if excessively added, this may lead to a reduced molecule weight of the polymer obtained, thereby resulting in deterioration of adhesion property of the sheet obtained. On the other hands, if the content is too low, the polymerization rate is lowered, and hence there may be a case where speeding up of a coating process cannot be attained. From these reasons, the content of the photopolymerization initiator is preferably 0.001 to 5 parts by mass, more preferably 0.01 to 5 parts by mass, and further preferably 0.05 to 3 parts by mass with respect to 100 parts by mass of the monomer components constituting the monomer mixture.

To activate the photopolymerizaton initiators, the acrylic polymerizable composition is irradiated with an active energy beam. Examples of such an active energy beam include ionizing radiation beams such as alpha ray, beta ray, gamma ray, neutron ray, electron ray, or ultraviolet ray, and particularly ultraviolet ray is suitable. The irradiation energy, irradiation time, etc. of the active energy beam are not particularly limited as long as it can activate the photopolymerization initiators and induce a reaction of monomer components.

In the present invention, cross-linking agents may be preferably used from the standpoint of improving durability by cross-linking an acrylic pressure-sensitive adhesive layer or maintaining the balance of foaming and peeling resistance.

As the crosslinking agents, the conventionally known one can be used, but, for example, polyisocyanate compounds, epoxy compounds, aziridine compounds, metal chelate compounds, and melamine compounds are preferably used In addition, polyfunctional (meth)acrylates can be utilized as the crosslinking agents. Among them, polyisocynate compounds or polyfunctional monomers are suitable. The crosslinking agents may be used alone or in combination of two or more thereof.

Examples of the polyisocynate compounds include tolylene diisocyanate, hexamethylene diisocyanate, polymethylene polyphenyl isocyanates, diphenyl methane diisocyanate, dimer of diphenyl methane diisocyanate, reaction products of trimethylol propane and tolylene diisocyante, reaction products of trimethylol propane and hexamethylene diisocyante, polyether polyisocyanates, and polyester polyisocyanates.

The polyfunctional (meth)acrylates man be used without particular limitation as long as it is a compound having at least two (meth)acryloyl groups. Examples thereof include trimethylol propane tri(meth)acrylate, tetramethylol methane tetraacrylate, pentaerythritol di(meth)acrylate, pentaerythritol tri(meth)acrylate, pentaerythritol tetra(meth)acrylate, 1,2-ethyleneglycol di(meth)acrylate, 1,4-butyleneglycol di(meth)acrylate, 1,6-hexanediol di(meth)acrylate, 1,12-dodecanediol di(meth)acrylate, dipentaerythritol monohydroxypenta(meth)acrylate, dipentaerythritol hexa(meth)acrylate, polyethyleneglycol di(meth)acrylate, hexanediol di(meth)acrylate, (poly)ethyleneglycol di(meth)acrylates, (poly)propyleneglycol di(meth)acrylates, neopentylglycol di(meth)acrylate, tetramethylohnethane tri(meth)acrylate, allyl(meth)acrylates, vinyl(meth)acrylate, epoxyacrylate, polyesteracrylates, urethaneacrylate, and reactive hyperbranched polymers having a plurality of (meth)acryloyl groups at the terminal [for example, trade name ‘CN2300’, ‘CN2301’, ‘CN2320’ manufactured by SARTOMER corporation).

The amount of the crosslinking agent added is not particularly limited as long as desirable gel fraction can be obtained. For example, the amount is preferably 0.001 to 5 parts by mass, more preferably 0.002 to 4 parts by mass, and further preferably 0.002 to 3 parts by mass, with respect to 100 parts by mass of the monomer components constituting the monomer mixture. If the amount is less than 0.001 parts by mass, there is a concern that the cohesive force of the acrylic pressure-sensitive adhesive layer is lowered. On the other hand, if the amount is more than 5 parts by mass, there is a concern that flexibility or tackiness of the acrylic pressure-sensitive adhesive layer is lowered.

Examples of other additives include: tackifiers such as rosin derivative resins, polyterpene resins, petroleum resins, and oil-soluble phenolic resins; plasticizers; fillers; anti-aging agents; surfactants; and the like. In addition, crosslinking accelerators may be used.

The acrylic pressure-sensitive adhesive layer is obtained by applying the acrylic polymerizable composition on a suitable support, and by curing the acrylic polymerizable composition applied on the support.

Furthermore, coating methods used at the time of coating are not particularly limited, and known methods may be used. Examples of the coating methods include a slot die coating, a reverse gravure coating, a microgravure coating, a dip coating, a spin coating, a brush coating, a roll coating, a flexo printing, and the like. As a coating equipment used at the time of coating, coating equipments which are generally used may be used without particular limitation. Examples of the coating equipments include roll coaters such as reverse coater, and gravure coater; curtain coaters; lip coaters; die coaters; knife coaters; and the like.

From the viewpoint of the compatibility of repelling resistance and pressure-sensitive adhesiveness, the acrylic pressure-sensitive adhesive layer has a gel fraction (solvent insoluble fraction) of preferably 20 to 80% by mass, and more preferably 25 to 75% by mass, and further preferably 30 to 70% by mass. If the gel fraction is less than 30% by mass, there is a concern that the cohesive force is insufficient, or adhesion reliability or processability is lowered. On the other hand, if the gel fraction is more than 80% by mass, there is a concern that the tackiness is insufficient, or adhesion reliability is lowered.

The gel fraction may be determined in the following manner. A porous polytetrafluoroethylene film (trade name ‘NTF-1122’ manufactured by Nitto Denko corporation, thickness of 85 μm) is cut into a size of 100 mm×100 mm, a kite string (width of 1.5 mm) is also cut into a length of approximately 100 mm, and the weight of them is measured (the weight of the porous polytetrafluoroethylene film and the kite string is regarded as ‘weight (A)’). Subsequently, a predetermined amount (approximately 1 g) of an acrylic pressure-sensitive adhesive layer is enclosed with the porous polytetrafluoroethylene film. An enclosed pore is tied using the kite string, and thus a packaging enclosing the pressure-sensitive adhesive layer (it may be also referred to as ‘pressure-sensitive adhesive layer-containing packaging’) is prepared. This pressure-sensitive adhesive layer-containing packaging is weighed, and the weight (A) of the porous polytetrafluoroethylene film and the kite string is subtracted from the weight of the pressure-sensitive adhesive layer-containing packing, to determine the weight of the acrylic pressure-sensitive adhesive layer. The weight of the acrylic pressure-sensitive adhesive layer is regarded as weight (B). Then, the pressure-sensitive adhesive layer-containing packaging is immersed in 50 ml of ethyl acetate for 7 days, and only the sol component of the acrylic pressure-sensitive adhesive layer is eluted out of the porous polytetrafluoroethylene film. After immersion, the pressure-sensitive adhesive layer-containing packaging immersed in ethyl acetate for 7 days is taken out, ethyl acetate which is stuck on the porous polytetrafluoroethylene film is wiped out, and the packaging is dried with a dryer at 130° C. for 2 hours. After drying, the pressure-sensitive adhesive layer-containing packaging is weighed. This weight of pressure-sensitive adhesive layer-containing packaging is regarded as weight (C).

The gel fraction (% by mass) of the acrylic pressure-sensitive adhesive layer is calculated by the following formula:

Gel fraction (% by mass)=[(C−A)/B×100]

The thickness of the acrylic pressure-sensitive adhesive layer is not particularly limited, but it is preferably 10 to 300 μm, more preferably 15 to 250 μm, and further preferably 20 to 200 μm, in terms of absorbing property for an impact from a protective panel, controlling property for the thickness of sheet coating, and the like. Furthermore, the acrylic pressure-sensitive adhesive layer may have a single-layer form or a lamination form.

(Release Liner)

An acrylic pressure-sensitive adhesive layer surface (adhesive face) of the acrylic pressure-sensitive adhesive sheet of the present invention may be protected by a release liner (separator, or release film) until being used. Furthermore, each of adhesive faces of the acrylic pressure-sensitive adhesive sheet may be protected by two sheets of release liners respectively, or may be protected by one sheet of release liner of which both faces are release faces, while being wound together into a roll form. The release liner is used as a protecting material for the acrylic pressure-sensitive adhesive layer and is peeled off when the layer is going to be laminated with an adherend. The release liner (separator) which is peeled off at the time of using (at the time of lamination) the acrylic pressure-sensitive adhesive sheet of the present invention is not included in the ‘base’ as described below.

As these release liners, commonly used release papers can be used. Examples thereof are not particularly limited, but include a base having a release-treated layer, a low adhesive base containing a fluorine polymer, a low adhesive base a containing non-polarity polymer, and the like. Examples of the low adhesive bases containing a fluorine polymer include a plastic film, paper, or the like, of which the surface is treated by release-treating agents such as silicone-based, long chain alkyl-type, fluorine-type, and molybdenum sulfide-type release-treating agents. Examples of the fluorine polymer for the low adhesive bases containing a fluorine polymer include polytetrafluoroethylenes, polychlorotrifluoroethylenes, polyvinyl fluorides, polyvinylidene fluorides, tetrafluoroethylene/hexafluoropropylene copolymers, chlorofluoroethylene/vinylidene fluoride copolymers, and the like. Examples of the non-polarity polymer for the low adhesive bases containing a non-polarity polymer include olefin resins (for example, polyethylenes and polypropylenes) and the like. The release liner may be formed by a known or commonly used method. Also, the thickness of release liner is not particularly limited.

(Other Layers)

The acrylic pressure-sensitive adhesive sheet of the present invention may have other layers (for example, an intermediate layer, or an undercoat layer) so long as it does not impair the effect of the present invention. More specifically, examples of these layers include a coating layer of a release agent for imparting peelability, a coating layer of an undercoat agent for improving close adhesive force, a layer for imparting a good deformability to the sheet, a layer for providing a larger area to be laminated with adherends, a layer for increasing an adhesive force to adherends, a layer for allowing the sheet to satisfactorily follow the surface slope of adherends, a layer for improving a treatability related to the reduction in the adhesive force by heating, a layer for improving a peelability after heating, and the like. In addition, the sheet may contain known or commonly used pressure-sensitive adhesive layers other than the aforementioned acrylic pressure-sensitive adhesive layer.

(Base)

The acrylic pressure-sensitive adhesive sheet of the present invention may have a base as a support, or may be a baseless type. When the acrylic pressure-sensitive adhesive sheet of the present invention is an acrylic pressure-sensitive adhesive sheet provided with a base, the base is not particularly limited, but examples include various optical films such as plastic films, anti-reflective (AR) films, polarizers, and retardation plates. Materials for the plastic films and the like include, for example, polyester resins such as polyethylene terephthalate (PET), acrylic resins such as polymethyl methacrylate (PMMA), polycarbonates, triacetylcelluoses, polysulfones, polyarylates, cyclic olefin polymers such as trade name ‘ARTON (cyclic olefin polymer manufactured by JSR corporation)’, and trade name ‘ZEONOR (cyclic olefin polymer manufactured by Nippon Zeon Co., Ltd.)’. These plastic materials may be used alone or in a combination of two or more thereof. Herein, the ‘base’ refers to a part laminated with adherends together with a pressure-sensitive adhesive layer when an acrylic pressure-sensitive adhesive sheet is laminated with the adherends (optical members, etc.). A release liner (separator) which is peeled off upon the use (lamination) of the acrylic pressure-sensitive adhesive sheet is not included in the ‘base’.

In particular, the base is preferably a transparent base. Herein, ‘transparent base’ refers to bases having total light transmittance in the wavelength range of visible light (as determined by JIS K 7361) of preferably 85% or more, and more preferably 90% or more. Examples of the transparent base include PET films, or non-oriented films such as trade name ‘ARTON’, trade name ‘ZEONOR’, and the like.

The thickness of the base is not particularly limited and is, for example, preferably 25 μm to 1500 μm. The base may have a single layer, or multiple layers. A surface of the base may also be suitably subject to known or commonly used treatments, for example, physical treatments such as corona discharge treatment and plasma treatment, and chemical treatments such as undercoat treatment, and the like.

(Method of Manufacturing an Acrylic Pressure-Sensitive Adhesive Sheet)

The acrylic pressure-sensitive adhesive sheet may be prepared by applying the acrylic polymerizable composition on a suitable support such as a base, curing the applied layer, and forming an acrylic pressure-sensitive adhesive layer.

More specifically, the acrylic pressure-sensitive adhesive sheet is manufactured through: (i) process of preparing a composition (acrylic polymerizable composition) containing a monomer mixture or a partially polymerized product thereof, in which the monomer mixture contains the aforementioned (m1), (m2) and (m3), or (m1), (m2), (m3) and (m4), and in which the content of each component (m1), (m2), (m3) and (m4) is 35 to 97.5% by mass, 2 to 40% by mass, 0.1 to 25% by mass, and 0 to 30% by mass, respectively; (ii) process of applying the composition prepared in process (i) on a support; and (iii) process of curing the composition applied on the support to form an acrylic pressure-sensitive adhesive layer.

In process (i), a monomer mixture or a partially polymerized product thereof containing monomer components constituting an acrylic polymer which is the main component of an acrylic pressure-sensitive adhesive layer is prepared, and if necessary a photopolymerization initiator or a cross-linking agent is added, resulting in preparing an acrylic polymerizable composition. In the present invention, since photopolymerization is preferred in terms of workability, manually thick-coating property, low environmental load, and the like, an acrylic polymerizable composition in which the photopolymerization initiator is added is preferable. For example, a composition containing at least: a monomer mixture or a partially polymerized product thereof, in which the monomer mixture contains the aforementioned (m1), (m2) and (m3), or (m1), (m2), (m3) and (m4), and in which the content of each component (m1), (m2), (m3) and (m4) is 35 to 97.5% by mass, 2 to 40% by mass, 0.1 to 25% by mass, and 0 to 30% by mass, respectively; and 0.001 to 5 parts by mass of photopolymerization initiator with respect to 100 parts by mass of monomer components constituting the monomer mixture may be used.

In process (ii), the composition prepared in process (i) is applied on a suitable support such as a base. A method of applying the composition on the support is not particularly limited, and commonly used method may be used. Such methods include, for example, a slot-die, a reverse gravure coating, a micro gravure, a dipping, a spin-coating, a brushing, a roll-coating, a flex-printing method, and the like.

In process (iii), the composition applied on the support is cured by various polymerization methods. For example, if a photopolymerization initiator is contained in the composition applied on the support, the composition may be cured using a photopolymerization method by irradiated with an active energy beam.

Furthermore, in the present invention, for forming a pressure-sensitive adhesive layer containing as a main component an acrylic polymer from the aforementioned acrylic polymerizable composition, various polymerization methods known in the art can be used to polymerize the acrylic polymerizable composition. Examples of the methods include methods using active energy beams such as an electron beam or a radiation beam, and methods using thermal polymerization initiators (solution polymerization, emulsion polymerization, bulk polymerization, etc.).

(Acrylic Pressure-Sensitive Adhesive Sheet)

The acrylic pressure-sensitive adhesive sheet of the present invention has at least the aforementioned acrylic pressure-sensitive adhesive layer. The acrylic pressure-sensitive adhesive sheet of the present invention may have any structure as long as it has at least the acrylic pressure-sensitive adhesive layer.

The acrylic pressure-sensitive adhesive sheet of the present invention may be a both-sides adhesive sheet in which both sides are adhesive faces, or may be a one-side adhesive sheet in which one side is an adhesive face. In addition, when the acrylic pressure-sensitive adhesive sheet of the present invention is the both-sides adhesive sheet, the adhesive faces may be provided by only the acrylic pressure-sensitive adhesive layer, or one adhesive face may be provided by the acrylic pressure-sensitive adhesive layer and the other adhesive face may be provided by a pressure-sensitive adhesive layer other than the acrylic pressure-sensitive adhesive layer.

Further, the acrylic pressure-sensitive adhesive sheet of the present invention may be formed in a wound roll form, or may be formed in a multilayered sheet form. That is, the acrylic pressure-sensitive adhesive sheet of the present invention may have sheet form, tape form, and the like. Referring to the form or mode of the acrylic pressure-sensitive adhesive sheet, that is wound into a roll, it may have the wound roll form or mode in which its adhesive faces are protected by release liners (separators), or may have the wound roll form or mode in which its adhesive face is protected by a release-treated layer (back side-treated layer) formed on the other surface of the support. In addition, examples of the release-treating agents (release agent) used in forming the release-treated layer (back side-treated layer) on the surface of the support include silicone-based release agents, long chain alkyl-based release agents or the like.

The acrylic pressure-sensitive adhesive sheet of the present invention exerts good corrosion resistance and adhesion reliability in the pressure-sensitive adhesive face of the acrylic pressure-sensitive adhesive layer. This good adhesion reliability is attributed to good adhesiveness to adherends, and also good ‘foaming and peeling resistance’ and ‘repelling resistance’. Herein, ‘foaming and peeling resistance’ means that failure in adhesion reliability, where a ‘floating’ or a ‘peeling’ by air bubbles generated from adherends (resin plates, etc.) occurs at an adhesive interface over time or under a stringent condition such as high temperature after laminated with adherend, does not occur. Also, ‘repelling resistance’ means that failure in adhesion reliability, where a ‘floating’ or a ‘peeling’ occurs at an adhesive interface over time or under a stringent condition such as high temperature after laminated with rounded adherends, does not occur. Moreover, ‘adhesion reliability’ is intended to indicate collectively the ‘foaming and peeling resistance’ and ‘repelling resistance’.

In the acrylic pressure-sensitive adhesive layer of the acrylic pressure-sensitive adhesive sheet of the present invention, an acrylic polymer as a main component containing (m1), (m2) and (m3), or (m1), (m2), (m3) and (m4) as monomer components, and the content of each component (m1), (m2), (m3) and (m4) is 35 to 97.5% by mass, 2 to 40% by mass, 0.1 to 25% by mass, and 0 to 30% by mass, respectively. Accordingly, even though the acrylic polymer does not substantially contain a carboxyl group, the ‘floating’ or ‘peeling’ by air bubble generated from adherends does not occur, excellent ‘foaming and peeling resistance’ is exerted, and excellent ‘repelling resistance’ is exerted where ‘floating’ or ‘peeling’ does not occur even when the adherend is rounded after the sheet is laminated with the adherend, as in the case of the use of carboxyl group-having monomers. Thus, the acrylic pressure-sensitive adhesive sheet of the present invention exerts good corrosion resistance and adhesion reliability in the adhesive face of the acrylic pressure-sensitive adhesive layer.

In the acrylic pressure-sensitive adhesive layer of the acrylic pressure-sensitive adhesive sheet of the present invention, the degree of cross-links may be adjusted by adding a cross-linking agent. If the acrylic pressure-sensitive adhesive layer has a suitable degree of cross-links, the ‘adhesion reliability’ may further be improved.

In the acrylic pressure-sensitive adhesive layer of the acrylic pressure-sensitive adhesive sheet of the present invention, when monomers constituting the acrylic polymer which is the main component of the layer do not contain a carboxyl group-having monomer, an increase in the impedance of metal thin films (including metal oxide thin films) such as ITO caused by an acidic component (corrosion of metal thin films) is prevented, and thus the sheet may be suitably used for applications such as laminating ITO film.

For example, the acrylic pressure-sensitive adhesive sheet of the present invention may be used for laminating optical members (optical members-laminating application). The optical members mean members involving optical properties (for example, polarization, light refraction, light scattering, light reflection, transmittance, light absorbance, light diffraction, optical rotation, and visibility). The optical members are not particularly limited as long as they involve such optical properties, and for example, include members constituting devices such as displays (image display) and input devices, and members used in these devices. Exemplary examples include polarizers, wave plates, retardation plates, optical compensation films, brightness-improving films, light guide plates, reflective films, anti-reflective film, transparent conductive films (ITO film), design film, decorative film, surface protective films, prisms, color filters, transparent substrates, and transparent resin plates, as well as members layered thereof. In addition, each of the aforementioned ‘plate’ and ‘film’ also includes forms of plate-type, film-type, sheet-type and the like. For example, ‘polarizer’ also includes ‘polarization film’, and ‘polarization sheet’.

The acrylic pressure-sensitive adhesive sheet of the present invention is particularly useful for the lamination of transparent conductive films (ITO film, etc.), the lamination of optical functional films with cupper meshes or silver sputters provided on their surfaces having a electromagnetic-absorbing function, and the like.

Examples of the display include liquid crystal displays, organic EL (electroluminescence) displays, PDP (plasma display panels), electronic papers, and the like. Further, examples of the input device include touch panels and the like.

Moreover, among them, the acrylic pressure-sensitive adhesive sheet of the present invention is preferably used for laminating members constituting the touch panel or members used in the touch panel (application for laminating members for touch panel). More specifically, it may be preferably used for laminating protective and/or decorative members for the touch panel such as surface protective films, design films, and decorative film. Also, it is preferably used for laminating the touch panel itself with a display (for example, a liquid crystal display).

The optical members (for example, members for touch panel) are not particularly limited, and for examples, include members (for example, sheet-, film-, or plate-type members) which are formed of acrylic resins, polycarbonates, polyethylene terephthalates, glasses, metal thin films and the like. Herein, the ‘optical member’ of the present invention includes members (design films, decorative films, surface protective films, or the like) which function for a decoration or protection while maintaining the visibility of adherendes such as displays or input devices.

Embodiments for laminating optical members using the acrylic pressure-sensitive adhesive sheet of the present invention are not particularly limited, and for example, include (1) an embodiment that optical members are laminated using the acrylic pressure-sensitive adhesive sheet of the present invention, (2) an embodiment that an optical member is laminated to a member other than optical members using the acrylic pressure-sensitive adhesive sheet of the present invention, and (3) an embodiment that the acrylic pressure-sensitive adhesive sheet of the present invention provided with an optical member is laminated with another optical member, or a member other than optical members. In case of the embodiment (1) or (2), the acrylic pressure-sensitive adhesive sheet of the present invention is preferably a both-sides adhesive sheet, and in case of the embodiment (3), the acrylic pressure-sensitive adhesive sheet of the present invention is preferably even if it is either type of a one-side adhesive sheet or a both-sides adhesive sheet. Moreover, in the embodiment (3), the acrylic pressure-sensitive adhesive sheet of the present invention is preferably a pressure-sensitive adhesive sheet having an optical member (such as optical films including polarization films) as its base.

By lamination, the acrylic pressure-sensitive adhesive sheet of the present invention to an optical member, a laminated construction of the optical member and the acrylic pressure-sensitive adhesive sheet having the form that the optical member contacts the acrylic pressure-sensitive adhesive layer is obtained. The aforementioned embodiments (1) to (3) include all such a laminated construction.

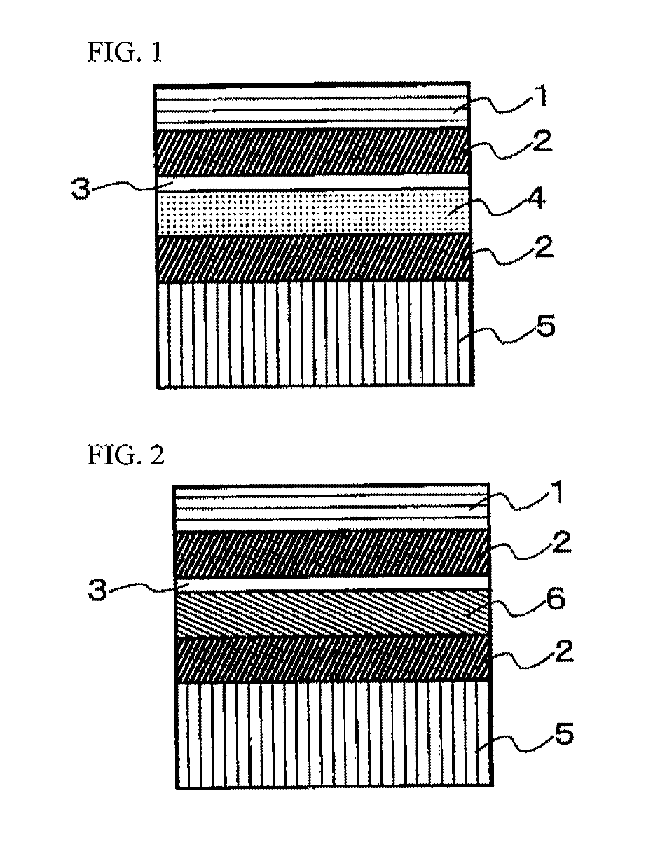

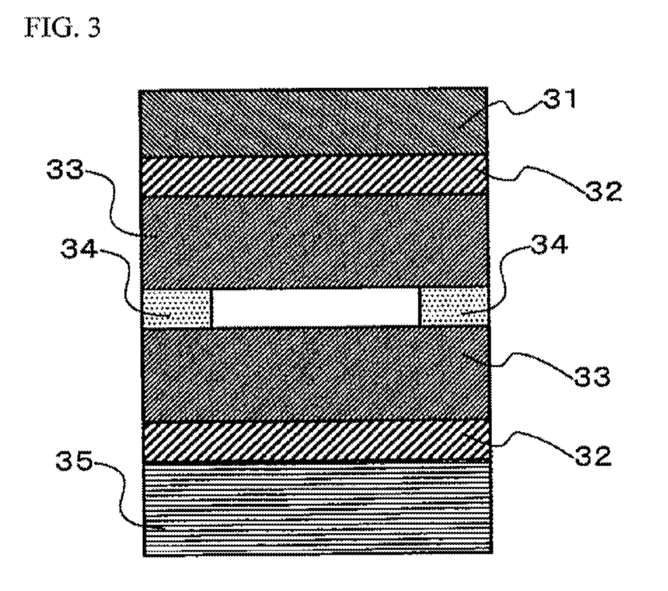

Furthermore, such a laminated construction may be used, for example, as an optical member having a pressure-sensitive adhesive. Particular examples of the members containing such a laminated construction include ‘capacitance-type touch panel’ as shown in FIG. 1 or FIG. 2, ‘resistive-type touch panel’ as shown in FIG. 3, or the like.

An example of a capacitance-type touch panel which is formed by laminating members using the acrylic pressure-sensitive adhesive sheet of the present invention is shown in FIG. 1 and FIG. 2 (cross-sectional view). The touch panel shown in FIG. 1 has resin plate 1 (for example, a reinforced plate such as polycarbonate or acrylic plates) laminated using the acrylic pressure-sensitive adhesive sheet 2 of the present invention with glass 4 provided with transparent conductive film 3 (conductive layer) of ITO on its surface. Display panel 5 is also laminated using the acrylic pressure-sensitive adhesive sheet 2 of the present invention with the opposite side of the glass plate coated ITO film. The touch panel shown in FIG. 2 has the constitution that glass 4 in FIG. 1 is changed to PET film 6.

The acrylic pressure-sensitive adhesive sheet of the present invention may also be used for laminating a polymethylmethacrylate (PMMA) plate on the surface of a transparent conductive PET film in which the surface is provided with a silver paste electrode (the height of 8 to 10 μm), for example, in a capacitance-type touch panel. In this case, to prevent the corrosion of the electrode, a high corrosion resistance acrylic pressure-sensitive adhesive sheet having an acrylic pressure-sensitive adhesive layer containing as a main component an acrylic polymer containing monomer components which do not substantially contain the aforementioned carboxyl group-having monomers may be preferably used.

In addition, an example of a resistive-type touch panel which is formed by laminating members using the acrylic pressure-sensitive adhesive sheet of the present invention is shown in FIG. 3 (cross-sectional view). The touch panel shown in FIG. 3 has two transparent conductive polyethylene terephthalate (PET) films 33 provided with transparent conductive films (conductive layer) of Indium Tin Oxide (ITO) formed on their surfaces, and conductive layer 34 which is sandwiched between two films 33, wherein conductive layer-forming sides of the two films is disposed in opposite to each other (face to face position). PET film 31 (design printed PET film) is also laminated using the acrylic pressure-sensitive adhesive sheet 32 of the present invention with one outside of the transparent conductive PET films 33 disposed in opposite to each other. And resin plate 35 (for example, a reinforced plate such as polycarbonate plates or acrylic plates) is also laminated using the acrylic pressure-sensitive adhesive sheet 32 of the present invention with the other outside of the transparent conductive PET films 33 disposed in opposite to each other.

### EXAMPLES

The present invention will be illustrated in detail based on examples below, but these examples are not to be construed as limiting the scope of the present invention.

### Usage Example 1 of Release Liner

A polyester film (trade name ‘MRF38’ manufactured by Mitsubishi Polyester Film GmbH) of which one surface is release-treated with a silicone-based release agent was used as a release liner (release film).

### Example 1

To 100 parts by mass of the mixture containing 86.5 parts by mass of 2-ethylhexylacrylate, 12 parts by mass of N-vinyl-2-pyrrolidone and 1.5 parts by mass of hydroxyethyl acrylamide, 0.05 parts by mass of 2,2-dimethoxy-1,2-diphenylethane-1-on (trade name ‘IRGACURE 651’ manufactured by Ciba Japan K.K.), and 0.05 parts by mass of 1-hydroxy-cyclohexyl-phenylketone (trade name ‘IRGACURE 184’ manufactured by Ciba Japan K.K.) were blended as photopolymerization initiators, and nitrogen gas was sufficiently introduced. The resulting mixture was exposed to ultraviolet light under a nitrogen atmosphere to allow photopolymerization, resulting in giving a partially polymerized product (syrup, or syrup-type composition) of which the conversion was 11%.

To the aforementioned partially polymerized product, 0.3 parts by mass of the reaction product of trimethylol propane with tolylene diisocyante (trade name ‘CORONATE L’ manufactured by Nippon Polyurethane Industry Co., Ltd., solid contents of about 75% by mass) as a cross-linking agent; and 0.05 parts by mass of 2,2-dimethoxy-1,2-diphenylethane-1-on (trade name ‘IRGACURE 651’ manufactured by Ciba Japan K.K.), and 0.05 parts by mass of 1-hydroxy-cyclohexyl-phenylketone (trade name ‘IRGACURE 184’ manufactured by Ciba Japan K.K.) as photopolymerization initiators were added. The resulting composition was applied on the release-treated surface of the release liner so as to give the final thickness of 150 μm, and thus a coating layer was formed.

Then, a polyester film (trade name ‘MRN38’ manufactured by Mitsubishi Polyester Film GmbH) of which one surface is release-treated with a silicone-based releaseing agent was laminated on the coating layer such that a release-treated surface thereof contacts the coating layer. The resulting sheet was subject to ultraviolet light irradiation under conditions of illuminance of 4 mW/cm² and quantity of light of 720 mJ/cm² to give a pressure-sensitive adhesive layer.

The gel fraction of the pressure-sensitive adhesive layer was 63.2% by mass.

### Example 2

A pressure-sensitive adhesive layer was prepared in the same manner as in

Example 1 except for using 100 parts by mass of the mixture containing 70 parts by mass of 2-ethylhexyl acrylate, 26 parts by mass of N-vinyl-2-pyrrolidone and 4 parts by mass of hydroxyethyl acrylamide; and adding 0.01 parts by mass of 1,6-hexanedioldiacrylate as a cross-linking agent.

The gel fraction of the pressure-sensitive adhesive layer was 63.2% by mass.

### Example 3

A pressure-sensitive adhesive layer was prepared in the same manner as in Example 1 except for using 100 parts by mass of the mixture containing 70 parts by mass of 2-ethylhexyl acrylate, 26 parts by mass of N-vinyl-2-pyrrolidone and 4 parts by mass of hydroxymethyl acrylamide (N-methylolacrylamide); and adding 0.03 parts by mass of 1,6-hexanedioldiacrylate as a cross-linking agent.

The gel fraction of the pressure-sensitive adhesive layer was 73.1% by mass.

### Example 4

A pressure-sensitive adhesive layer was prepared in the same manner as in Example 1 except for using 100 parts by mass of the mixture containing 71 parts by mass of 2-ethylhexyl acrylate, 11 parts by mass of N,N-diethyl acrylamide, 15 parts by mass of N-vinyl-2-pyrrolidone, 1.5 parts by mass of hydroxyethyl acrylamide and 1.5 parts by mass of N-methylol acrylamide; and adding 0.2 parts by mass of the reaction product of trimethylol propane with tolylene diisocyante (trade name ‘CORONATE L’ manufactured by Nippon Polyurethane Industry Co., Ltd., solid contents of about 75% by mass) as a cross-linking agent.

The gel fraction of the pressure-sensitive adhesive layer was 52.6% by mass.

### Comparative Example 1

A pressure-sensitive adhesive layer was prepared by in same manner as in Example 1 except for using 100 parts by mass of the mixture containing 90 parts by mass of 2-ethylhexyl acrylate and 10 parts by mass of acrylic acid; and adding 0.04 parts by mass of 1,6-hexanediol diacrylate as a cross-linking agent.

The gel fraction of the pressure-sensitive adhesive layer was 74.3% by mass.

### Comparative Example 2

A pressure-sensitive adhesive layer was prepared in the same manner as in Example 1 except for using 100 parts by mass of the mixture containing 100 parts by mass of 2-ethylhexyl acrylate; and adding 0.1 parts by mass of 1,6-hexanediol diacrylate as a cross-linking agent.

The gel fraction of the pressure-sensitive adhesive layer was 66% by mass.

### Comparative Example 3

A pressure-sensitive adhesive layer was prepared in the same manner as in Example 1 except for using 100 parts by mass of the mixture containing 85 parts by mass of 2-ethylhexyl acrylate and 15 parts by mass of N-vinyl-2-pyrrolidone; and adding 0.08 parts by mass of 1,6-hexanediol diacrylate as a cross-linking agent.

The gel fraction of the pressure-sensitive adhesive layer was 77.8% by mass.

### Comparative Example 4

A pressure-sensitive adhesive layer was prepared in the same manner as in Example 1 except for using 100 parts by mass of the mixture containing 96 parts by mass of 2-ethylhexyl acrylate and 4 parts by mass of hydroxyethyl acrylamide, and adding 0.05 parts by mass of 1,6-hexanediol diacrylate as a cross-linking agent.

The gel fraction of the pressure-sensitive adhesive layer was 26.6% by mass.

(Evaluation)

The sheets prepared in Examples and Comparative Examples was evaluated by testing or determining gel fraction, ITO corrosion resistance, adhesiveness, repelling resistance, foaming and peeling resistance and transparency (optical property). The results are shown in Table 1.

(Method for Determining Gel Fraction)

A porous polytetrafluoroethylene film (trade name ‘NTF-1122’ manufactured by Nitto Denko corporation, thickness of 85 μm) was cut into a size of 100 mm×100 mm, and also a kite string (width of 1.5 mm) was cut into a length of approximately 100 mm, and the weight of them was measured (the weight of the porous polytetrafluoroethylene film and the kite string is regarded as ‘weight (A)’).

Then, release liners were removed from both sides of the adhesive sheets prepared in Examples and Comparative Examples, which were cut into a size of 7 cm², and each of the pressure-sensitive adhesive layers was enclosed with the porous polytetrafluoroethylene film. Then, the each enclosed pores were tied using the kite strings, and thus packagings each enclosing one of the pressure-sensitive adhesive layers (it is also referred to as ‘pressure-sensitive adhesive layer-containing packaging’) were prepared. Each of these pressure-sensitive adhesive layer-containing packagings was weighed, and the weight (A) of the porous polytetra fluoroethylene film and the kite string is subtracted from the weight of the pressure-sensitive adhesive layer-containing packing, to determine the weight of the sample (pressure-sensitive adhesive layer). The weight of the sample is regarded as weight (B).

Then, each of the pressure-sensitive adhesive layer-containing packagings was immersed in 50 ml of ethyl acetate for 7 days, and only the sol component of the pressure-sensitive adhesive layer was eluted out of the porous polytetrafluoroethylene film. After immersion, the pressure-sensitive adhesive layer-containing packaging immersed in ethyl acetate for 7 days was taken out, ethyl acetate which was stuck on the porous polytetrafluoro ethylene film was wiped out, and the packaging was dried with a dryer at 130° C. for 2 hours. After drying, the pressure-sensitive adhesive layer-containing packaging was weighed. This weight of pressure-sensitive adhesive layer-containing packaging is regarded as weight (C).

Then, the gel fraction (% by weigh:) of each of the pressure-sensitive adhesive layer was calculated by the following formula:

Gel fraction (% by weight)=[(C−A)/B×100)

(Method for Evaluating ITO Corrosion Resistance)

Release liners were removed from one side of the pressure-sensitive adhesive sheets prepared in Examples and Comparative Examples, and each of the exposed adhesive faces was laminated with polyethyleneterephthalate film. (thickness of 50 μm) which was not release-treated. Then, the other release liners were removed, and pressure-sensitive adhesive layers were exposed to thereby obtain pressure-sensitive adhesive sheets for a bridging usage.

A silver paste was applied on the both ends of a conductive film-formed surface of transparent conductive film (trade name ‘ELECRYSTA’ manufactured by Nitto Denko corporation, containing ITO layer on its surface as a conductive film) to form electrodes. The adhesive face of each of the aforementioned pressure-sensitive adhesive sheets for a bridging usage was laminated with the electrodes of the transparent conductive film such that some of the adhesive face in the exposed pressure-sensitive adhesive layers was mounted on same of the electrodes at the both ends (that is, such that it just bridges between the electrodes), to prepare samples for the evaluation of corrosion resistance. Then, in each sample, electrical impedance between both silver electrodes was read using electrical impedance tester, and this initial value was taken to as 100.

Then, these samples for the evaluation of corrosion resistance were placed in a humidified atmosphere (60° C., 95% RH), and the same impedance was read over time. When the initial value is taken as 100, if the value of electrical impedance after 6 days was no more than 110, it is evaluated as ‘good (A)’; and if the value was changed to more than 110, it is evaluated as ‘failure (B)’.

(Method for Measuring Adhesiveness)

Release liners (MRN 38) were removed from one side of the pressure-sensitive adhesive sheets prepared in Examples and Comparative Examples, and each of the exposed adhesive faces was laminated with polyethyleneterephthalate film (thickness of 50 μm) which was not release-treated. Then, the resulting sheets were cut into the width of 25 mm to obtain samples for measurement.

Then, release liners (MRF38) were removed from the samples for measurement, and each sheet was pressed to a clean acrylic plate (AC Plate) and a clean polycarbonate plate (PC Plate) which each plate was cleaned by rubbing 10 times using a clean waste impregnated with isopropyl alcohol, by reciprocating one time with a 2 kg roller, and the resulting samples were stored at 40° C. for 2 days.

After storage, these samples were placed at room temperature (about 23° C.) for 30 min., and adhesiveness to acrylic plate and polycarbonate plate were measured by peeling with 90° peel at a rate of 300 mm/min. using a tensil tester (model name ‘TCM-1kNB’ manufactured by Minebeya Co., Ltd.).

(Method for Evaluating Repelling Resistance)

The pressure-sensitive adhesive sheets prepared in Examples and Comparative

Examples were cut into a size of 10 mm×90 mm, and release liners (MRN38) were removed from one side of each of the cut sheets. Then, each of the exposed adhesive faces was laminated with the same sized aluminum plate (thickness of 0.5 mm). Then, each of the resulting sheets was rounded with R50 curvature in such a manner that the pressure-sensitive layer faced outside, and adhesive faces were exposed by removing the other release liners (MRF38). Each adhesive face was pressed to a clean acrylic plate which was cleaned by rubbing 10 times using a clean waste impregnated with isopropyl alcohol, by using a laminator so as not to form floating. The resulting samples were placed at room temperature (about 20 to 25° C.) for 24 hours, and observed whether floating from acrylic plates at both ends of the tape was generated.

The case that no floating was generated, or even if floating was observed, the case that the floating distance (distance from the acrylic plate at the end of tape) was no more than 1.0 mm was evaluated as ‘good (S)’; the case that the floating distance was 1.0 to 2.0 mm was evaluated as ‘normal (A)’; and the case that the floating distance was more than 2.0 mm was evaluated as ‘failure (B)’.

(Foaming and Peeling Resistance Test)

Release liners (MRN38) were removed from one side of the pressure-sensitive adhesive sheets prepared in Examples and Comparative Examples, and each of the exposed adhesive faces was laminated with polyethyleneterephthalate film (thickness of 50 μm) which was not release-treated. The resulting sheets were cut into a size of 50 mm×50 mm to obtain samples.

Then, release liners (MRN38) were removed from the samples. Each sheet was laminated with an acrylic plate (thickness of 1.5 mm) by using a laminator, and the samples were fitted sufficiently. The resulting samples were placed at 80° C. atmosphere for 4 days, and observed whether foaming and peeling or floating from the acrylic plate was generated at the adhesive face.

The case that no foam was generated, or the case that only foams having diameter (longer diameter in the case of an oval shape) of no more than 0.05 mm size was observed was evaluated as ‘good (S)’; the case that foams (longer diameter in the case of an oval shape) having diameter of 0.05 to 5 mm size was observed was evaluated as ‘normal (A)’; and the case that foams (longer diameter in the case of an oval shape) having diameter of more than 5 mm size was observed was evaluated as ‘failure (B)’.

(Method for Evaluating Transparency)

Release liners (MRN38) were removed from one side of the pressure-sensitive adhesive sheets prepared in Examples and Comparative Examples, each of the exposed adhesive faces was laminated with a glass having 1 mm thickness (MATSUNAMI GLASS IND., LTD.; microslide glass; white crown glass), and then the other release liners (MRF38) were removed to obtain samples.

Total light transmittance and haze for these samples were measured using a haze meter (model name ‘HM-150’ manufactured by MURAKAMI Color Research Laboratory) to evaluate transparency (optical property).

TABLE 1

| | | | | | Cross- | | | | | | | | | |
|---|---|---|---|---|---|---|---|---|---|---|---|---|---|---|
| | | | | | linking | | | | | | | | | |
| | | | | | agent | | | Adhesiveness | | | | | | |
| | Composition of | | | | Kind and | Gel | | (90° peel | | Repelling resistance | | | Optical property | |
| | monomers | | | | amount used | fraction | ITO | adhesiveness) | | Floating | | Foaming | Total light | |
| | [parts by mass] | | | | [parts by | [% by | corrosion | AC | PC | distance | | and peeling | transmittance | |
| | (m1) | (m2) | (m3) | (m4) | mass] | mass] | resistance | Plate | Plate | [mm] | Evaluation | resistance | [%] | Haze |
| Ex. 1 | 86.5 | 12 | 1.5 | | C/L | 63.2 | A | 34 | 45 | 0.4 | S | S | 92.2 | 0.7 |
| | | | | | 0.3 | | | | | | | | | |
| Ex. 2 | 70 | 26 | 4 | | HDDA | 63.2 | A | 29 | 57 | 0.5 | S | S | 92.1 | 0.5 |
| | | | | | 0.01 | | | | | | | | | |
| Ex. 3 | 70 | 26 | 4 | | HDDA | 73.1 | A | 30 | 49 | 0 | S | S | 92.0 | 0.9 |
| | | | | | 0.03 | | | | | | | | | |
| Ex. 4 | 71 | 26 | 3 | | C/L | 52.6 | A | 30 | 36 | 0.5 | S | S | 92.0 | 0.8 |
| | | | | | 0.2 | | | | | | | | | |
| Comp. | 90 | | | 10 | HDDA | 74.3 | B | 25 | 27 | 1.9 | A | A | 92.3 | 0.4 |
| Ex. 1 | | | | | 0.04 | | | | | | | | | |
| Comp. | 100 | | | | HDDA | 66.0 | A | 15 | 15 | 28 | B | B | 92.3 | 0.5 |
| Ex. 2 | | | | | 0.1 | | | | | | | | | |
| Comp. | 85 | 15 | | | HDDA | 77.8 | A | 22 | 30 | 1.1 | A | B | 92.2 | 0.4 |
| Ex. 3 | | | | | 0.08 | | | | | | | | | |
| Comp. | 96 | | 4 | | HDDA | 26.6 | A | 49 | 40 | 26 | B | B | 92.1 | 9.9 |
| Ex. 4 | | | | | 0.05 | | | | | | | | | |

In Table 1, ‘C/L’ in cross-linking agents indicates ‘a reaction product of trimethylol propane and tolylene diisocyanate (trade name ‘CORONATE L’ manufactured by Nippon Polyurethane Industry Co., Ltd.) as a cross-linking agent, and ‘HDDA’ indicates ‘1,6-hexanediol diacrylate’.

Each of pressure-sensitive adhesive sheets prepared in Examples has good ITO corrosion resistance, and also exerts good properties in adhesion reliability such as adhesiveness, repelling resistance, and foaming and peeling resistance. As can be seen from Table 1, each of pressure-sensitive adhesive sheets prepared in Examples has good ITO corrosion resistance compared to that of Comparative Example 1. Also, they exert good properties in adhesion reliability such as adhesiveness, repelling resistance, and foaming and peeling resistance compared to those of Comparative Examples 2 and 3. In addition, pressure-sensitive adhesive sheets prepared in Examples exert excellent transparency compared to that of Comparative Example 4.

The present application is based on Japanese Patent Application No. 2008-306341 filed on Dec. 1, 2008, and contents thereof are incorporated herein by reference.

### INDUSTRIAL APPLICABILITY

The acrylic pressure-sensitive adhesive sheet of the present invention has high corrosion resistance and adhesion reliability for, in particular, transparent electrodes such as ITO. Accordingly, the sheet is useful as a pressure-sensitive adhesive sheet for laminating optical members.

### REFERENCE SIGNS LIST

1 resin plate
2 acrylic pressure-sensitive adhesive sheet
3 transparent conductive film
4 glass
5 image displaying panel
6 polyethyleneterephthalate film (PET film)
31 polyethyleneterephthalate film (PET film)
32 acrylic pressure-sensitive adhesive sheet
33 transparent conductive PET film
34 conductive layer
35 resin plate

1. An acrylic pressure-sensitive adhesive sheet comprising at least an acrylic pressure-sensitive adhesive layer comprising as a main component an acrylic polymer formed from a composition comprising a monomer mixture or a partially polymerized product thereof, wherein the monomer mixture comprises the following (m1), (m2) and (m3), or (m1), (m2), (m3) and (m4), and wherein a content of each component (m1), (m2), (m3), and (m4) is 35 to 97.5% by mass, 2 to 40% by mass, 0.1 to 25% by mass, and 0 to 30% by mass, respectively:
(m1) an alkyl(meth)acrylate monomer having an alkyl group with 1 to 12 carbon atoms, which is represented by Formula (1),
CH₂═C(R¹)COOR² (1)
(in Formula (1), R¹ represents a hydrogen atom or a methyl group, and R² represents an alkyl group with 1 to 12 carbon atoms);
(m2) a vinylic monomer having a nitrogen atom(s) in its skeleton (excluding (m3));
(m3) an N-hydroxyalkyl(meth)acrylamide monomer having a hydroxyalkyl group with 1 to 4 carbon atoms; and
(m4) a monomer copolymerizable with the above-described (m1) to (m3).

2. The acrylic pressure-sensitive adhesive sheet according to claim 1, wherein the vinylic monomer having a nitrogen atom(s) in its skeleton (m2) is one or two or more monomers selected from N-vinyl cyclic amides represented by Formula (2), or (meth)acrylamides, 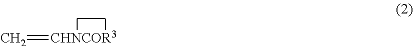
(in Formula (2), R³ represents a divalent organic group),

3. The acrylic pressure-sensitive adhesive sheet according to claim 1, wherein the composition containing the monomer mixture or the partially polymerized product thereof further comprises a cross-linking agent added in an amount of 0.001 to 5 parts by mass with respect to 100 parts by mass of monomer components constituting the monomer mixture.

4. The acrylic pressure-sensitive adhesive sheet according to claim 1, wherein the acrylic pressure-sensitive adhesive sheet is used for optical members.

5. The acrylic pressure-sensitive adhesive sheet according to claim 1, wherein the acrylic pressure-sensitive adhesive sheet is a baseless-type both-sides pressure-sensitive adhesive sheet consisting of the acrylic pressure-sensitive adhesive layer.

6. A method of manufacturing an acrylic pressure-sensitive adhesive sheet, wherein the method comprises:
(i) preparing a composition comprising: at least a monomer mixture or a partially polymerized product thereof, wherein the monomer mixture comprises the following (m1), (m2) and (m3), or (m1), (m2), (m3) and (m4), and wherein a content of each component (m1), (m2), (m3), and (m4) is 35 to 97.5% by mass, 2 to 40% by mass, 0.1 to 25% by mass, and 0 to 30% by mass, respectively; and 0.001 to 5 parts by mass of a photopolymerization initiator with respect to 100 parts by mass of monomer components constituting the monomer mixture or the partially polymerized product thereof;
(ii) applying the composition prepared in process (i) on a support; and
(iii) curing the composition applied on the support by irradiating with an active energy beam to form an acrylic pressure-sensitive adhesive layer:
(m1) an alkyl(meth)acrylate monomer having an alkyl group with 1 to 12 carbon atoms, which is represented by Formula (1),
CH₂═C(R¹)COOR² (1)
(in Formula (1), R¹ represents a hydrogen atom or a methyl group, and R² represents an alkyl group with 1 to 12 carbon atoms);
(m2) a vinylic monomer having a nitrogen atom(s) in its skeleton;
(m3) an N-hydroxyalkyl(meth)acrylamide monomer having a hydroxyalkyl group with 1 to 4 carbon atoms; and
(m4) a monomer copolymerizable with the above-described (m1) to (m3).

7. A laminated construction of an acrylic pressure-sensitive adhesive sheet and an optical member in a contact state of the acrylic pressure-sensitive adhesive layer with the optical member, wherein the acrylic pressure-sensitive adhesive sheet is the acrylic pressure-sensitive adhesive sheet according to claim 1.
